(19) United States
(12) Patent Application Publication
(10) Pub. No.: US 2008/0215489 A1
(43) Pub. Date: Sep. 4, 2008

(54) Method And Apparatus For Authentication Of Invoices

(76) Inventors: Marcus Maxwell Lawson, Hampshire (GB); Francis Kirkman Fox, Hampshire (GB)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/817,077

(22) PCT Filed: Feb. 23, 2006
(86) PCT No.: PCT/GB06/00640

§ 371 Date: Nov. 28, 2007

(30) Foreign Application Priority Data
Feb. 25, 2005 (GB) 0503970.6

(51) Int. Cl. G06Q 10/00

(52) U.S. Cl. 705/50; 705/34

(57) ABSTRACT

The security of invoices as between purchaser and supplier may be improved by printing a data matrix symbol or other glyph on the invoice. The data matrix contains two layers or portions of data. The first layer or portion contains invoice data and the second layer or portion contains secure data relating to the purchaser and supplier. This may include a trusted supplier status, a trusted supplier code and a unique voice identifier, or a reference thereto. On receipt of the invoice by the purchaser the data matrix is scanned and the trusted supplier status and supplier codes retrieved. These may be compared against a store of codes and status to verify the invoice as authentic. The secure data or a reference to the secure data may be re-encoded into a data matrix which may be affixed to a remittance advice sent by the purchaser to the supplier.

This invention relates to the generation and processing of invoices and in particular to increasing the security aspects of invoice transmittal and settlement, and reducing the time required to process invoices for payment.

The processing of invoices for payment can be a very time consuming and labour intensive process. A company accounts department must enter all received invoices into its purchase ledger and then make decisions as to whether and when individual invoices should be paid. Typically, turning paper invoices back into useful data that can be used by accounting software requires the invoices to be keyed into an accounting software package such as SAGE™ provided by the Sage Group PLC of the United Kingdom. Data entry into accounts packages represents a high overhead in terms of manpower and, therefore, cost.

In practice, many suppliers to a given purchaser company may work regularly with the company and invoices from regular suppliers will not be scrutinised as carefully as those from less regular or one-off suppliers. There is a greater degree of trust from regular suppliers and, although the amount of an invoice may be checked, an invoice from a regular supplier will most probably be automatically treated as genuine. However, all received invoices have to be processed manually and an assessment made as to whether an individual invoice comes from a trusted supplier. In some companies, invoicing for less than a certain amount will be paid automatically as it is not worth the overhead of checking each invoice manually.

Present procedures for entering supplier invoices into accounting packages are therefore slow and inefficient and security is haphazard. The invention aims to address these problems.

In its broadest from, the invention resides in the use of an encoded symbol or glyph carried on an invoice that contains information regarding the supplier. This symbol can be read automatically by a purchaser who can determine whether or not the supplier is trusted. This adds greatly to the security aspects of invoice processing and makes it simple to identify invoices from trusted suppliers.

More specifically, the invention provides a system for generation and verification of invoices between a supplier and purchaser comprising: a store of identifiers of trusted suppliers; an invoice generator for generating invoices, each invoice including a graphic symbol having encoded therein the supplier's trusted identifier or a reference to the supplier's trusted identifier; a scanner at the supplier for scanning the encoded graphic symbol for retrieval of the trusted supplier identifier; and a verifier for comparing the retrieved trusted supplier identifier with stored trusted identifiers to authenticate the invoice as originating from a trusted supplier.

The symbol may include an encoded invoice identifier or a reference to an invoice identifier and the trusted suppler identifier may comprise a trusted supplier status and a trusted supplier code. The trusted supplier identifier or a reference thereto may be encoded in a first data portion on the graphic symbol, for example in encrypted form. A second data portion may encode or reference actual invoice details. Thus there is a distinction between the first data portion which carries information regarding the trusted relationship between supplier and purchaser, and the second data portion which carries data specific to an individual invoice.

Different levels of security may be used for each layer. Both may be encrypted or hashed but not necessarily using the same hash or encryption algorithm. This enables the data in the two layers to be made selectively available to other parties depending on their entitlement.

Preferred embodiments of the invention not only improve security in the handling of invoices but also may greatly reduce processing time as all the invoice details may be scanned directly from the symbol into the purchaser's accounts software. This eliminates the need for time-consuming entry of invoices into a purchase ledger.

The invention also provides a system for generation and verification of invoices between a supplier and purchaser comprising: a store of identifiers of trusted suppliers; an invoice generator for generating invoices, each invoice including a graphic symbol having encoded therein data relating to the supplier's trusted identifier; a scanner at the supplier for scanning the encoded graphic symbol for retrieval the data related to trusted supplier identifier; means for retrieving the trusted supplier identifier from the data related to the trusted supplier identifier and a verifier for comparing the retrieved trusted supplier identifier with stored trusted identifiers to authenticate the invoice as originating from a trusted supplier.

Preferred embodiments of the invention will now be described, by way of example only, with reference to the accompanying drawing in which:

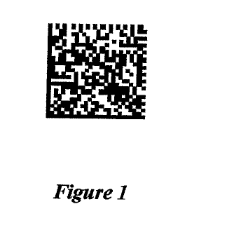

FIG. 1 is a view of a data matrix;

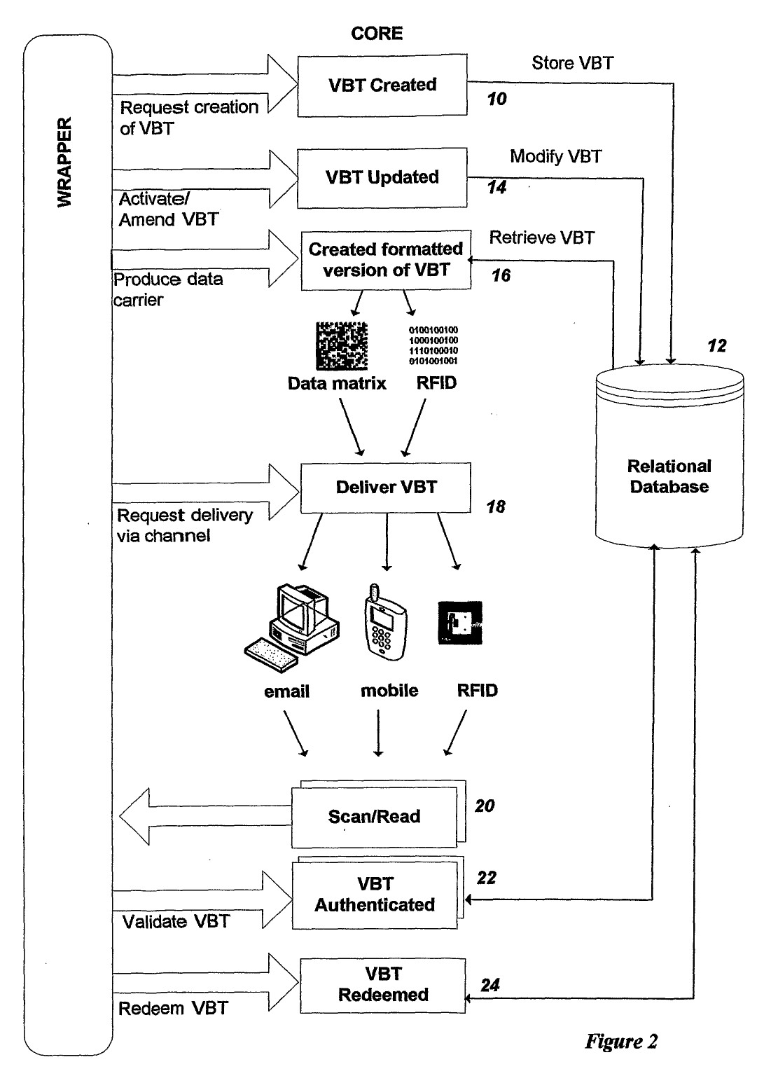

FIG. 2 is a schematic diagram of the core and wrapper of a system embodying the present invention;

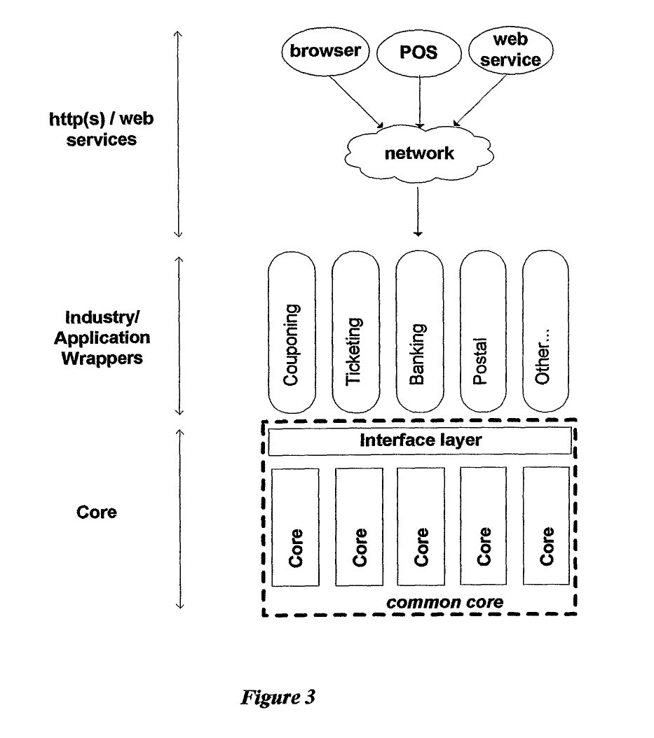

FIG. 3 shows how the core of FIG. 2 may be used with a plurality of different application wrappers;

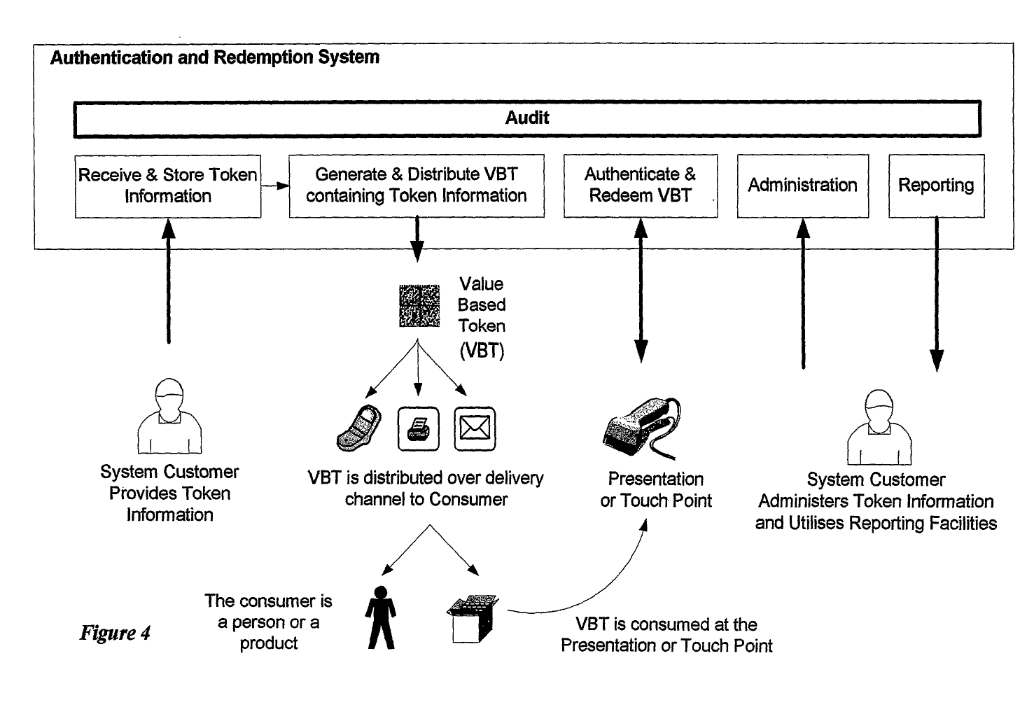

FIG. 4 is a schematic representation of the functionality of the system;

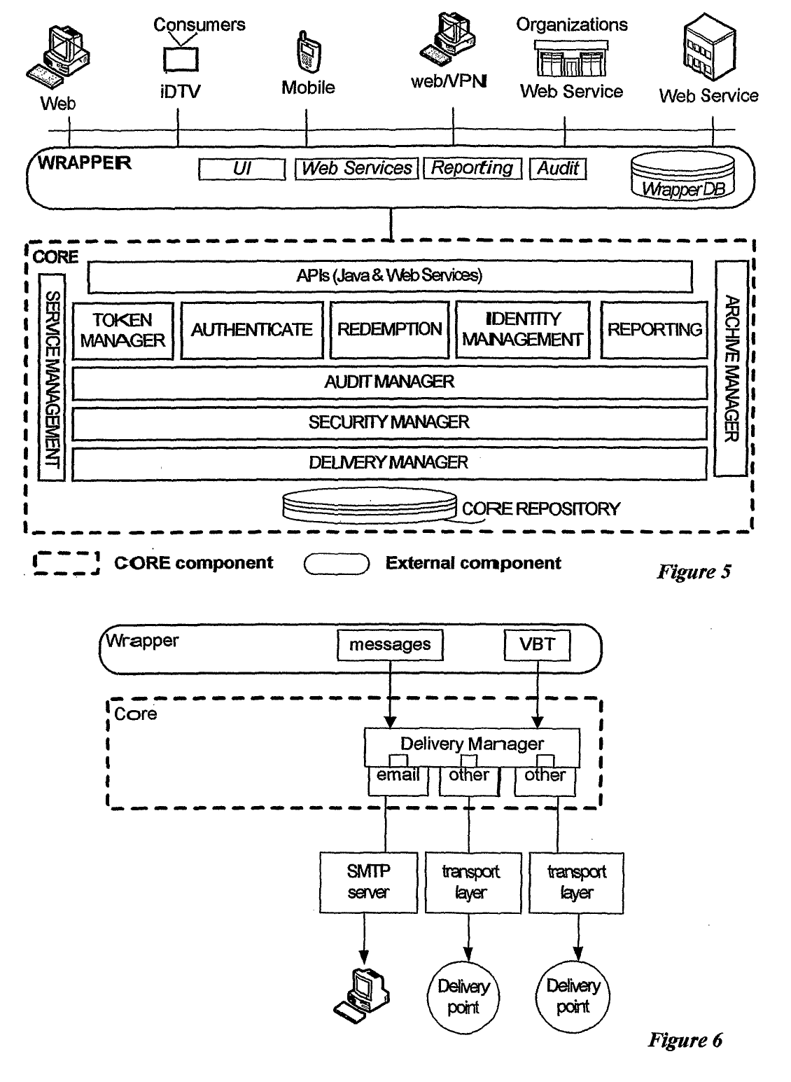

FIG. 5 is a representation of the software components of the core of the system of FIG. 2 providing the functionality of FIG. 4;

FIG. 6 is a representation of the functionality of the delivery manager of FIG. 5;

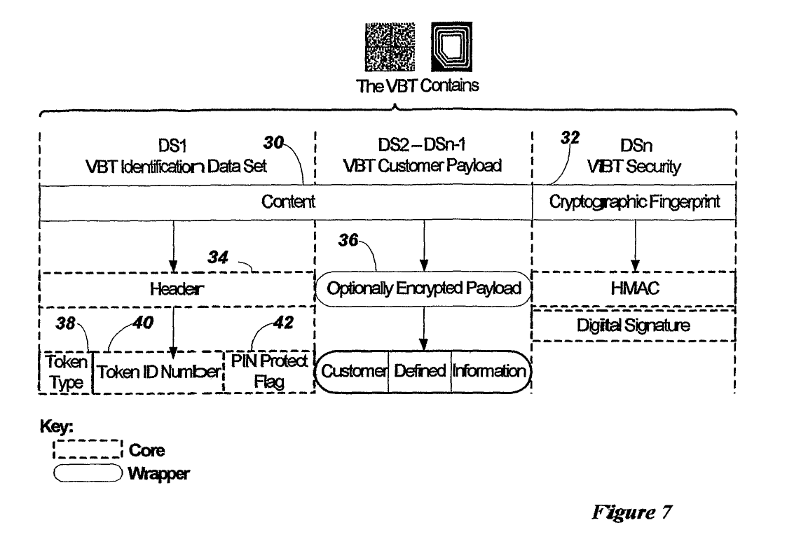

FIG. 7 shows the structure of a value based token embodying the invention;

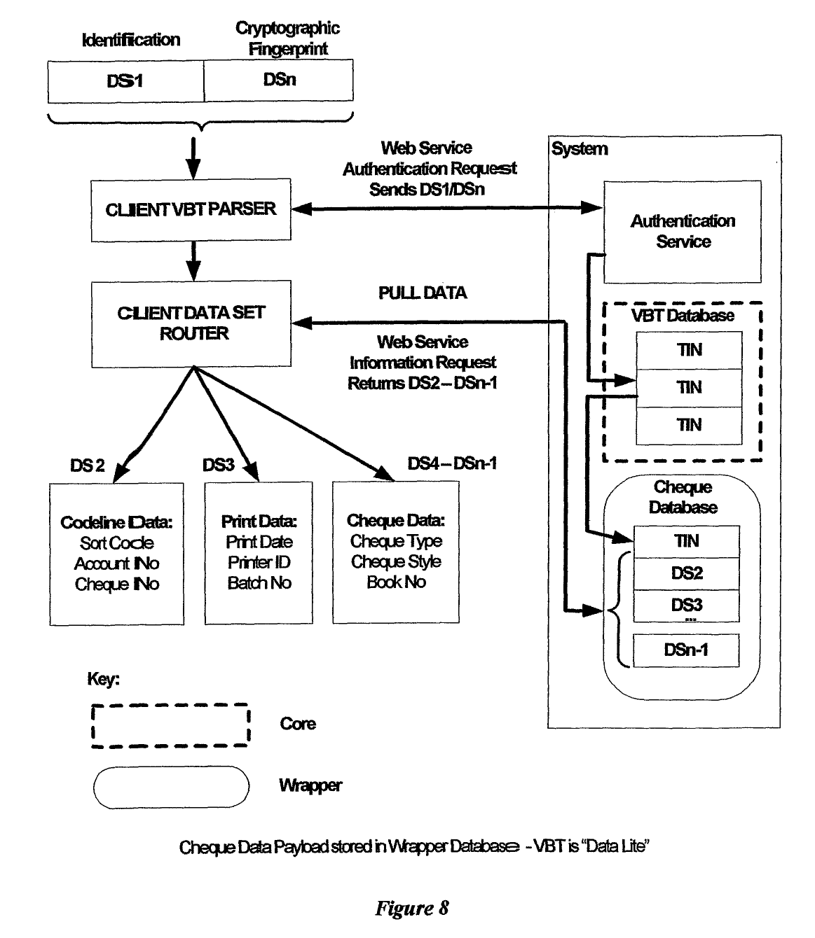

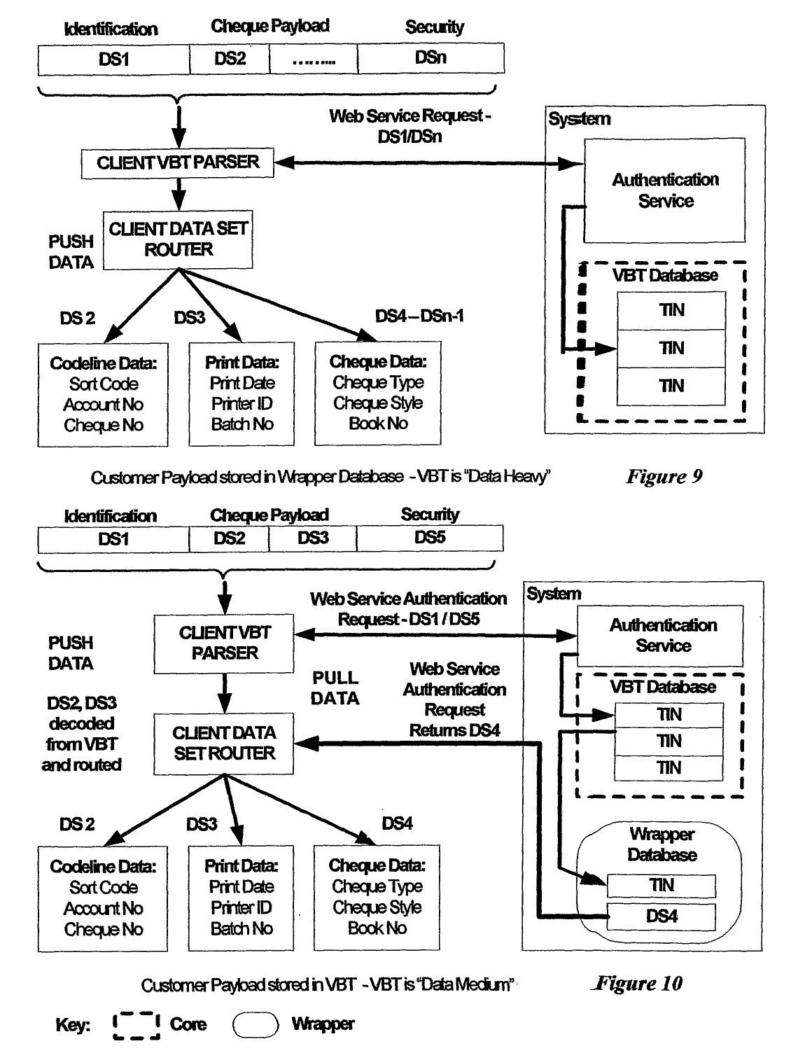

FIGS. 8 and 9 show, respectively, embodiments using data lite and data heavy value based tokens;

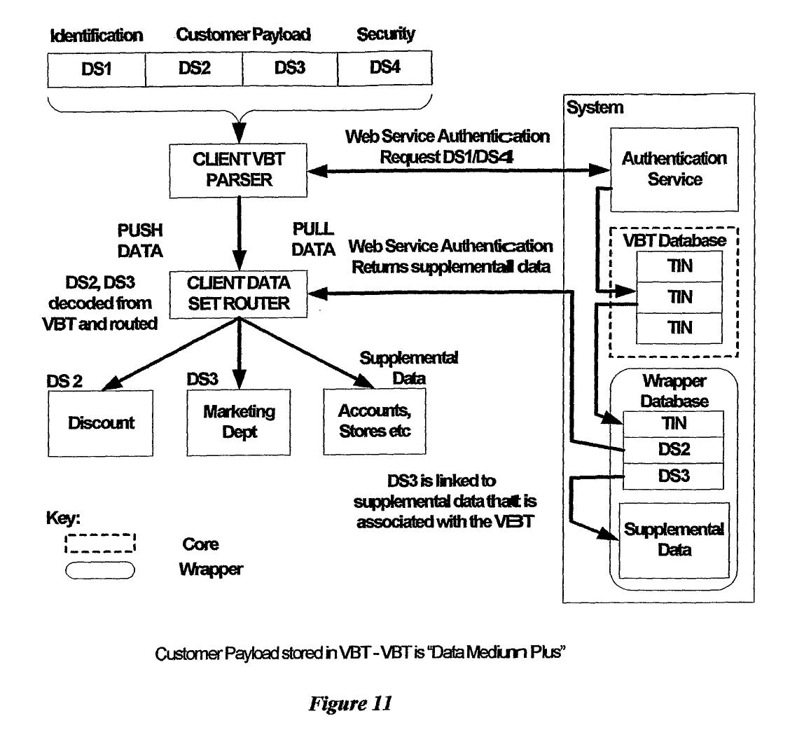

FIGS. 10 and 11, respectively, show VBTs having intermediate amounts of data in the token;

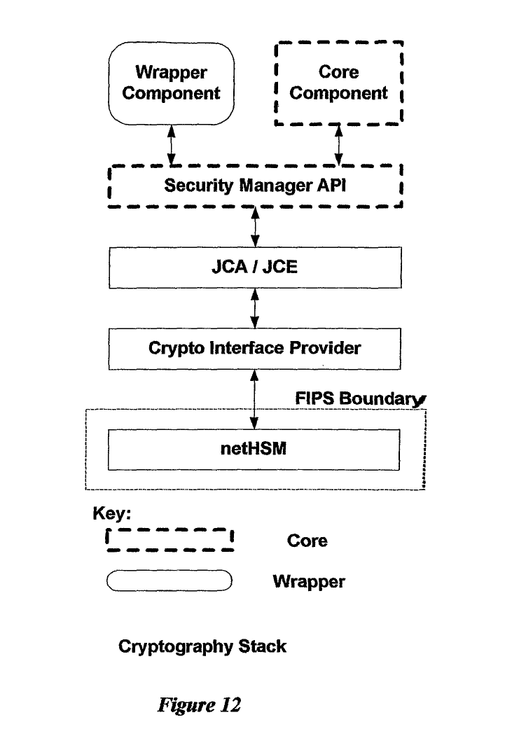

FIG. 12 is a schematic diagram showing cryptographic functions; and

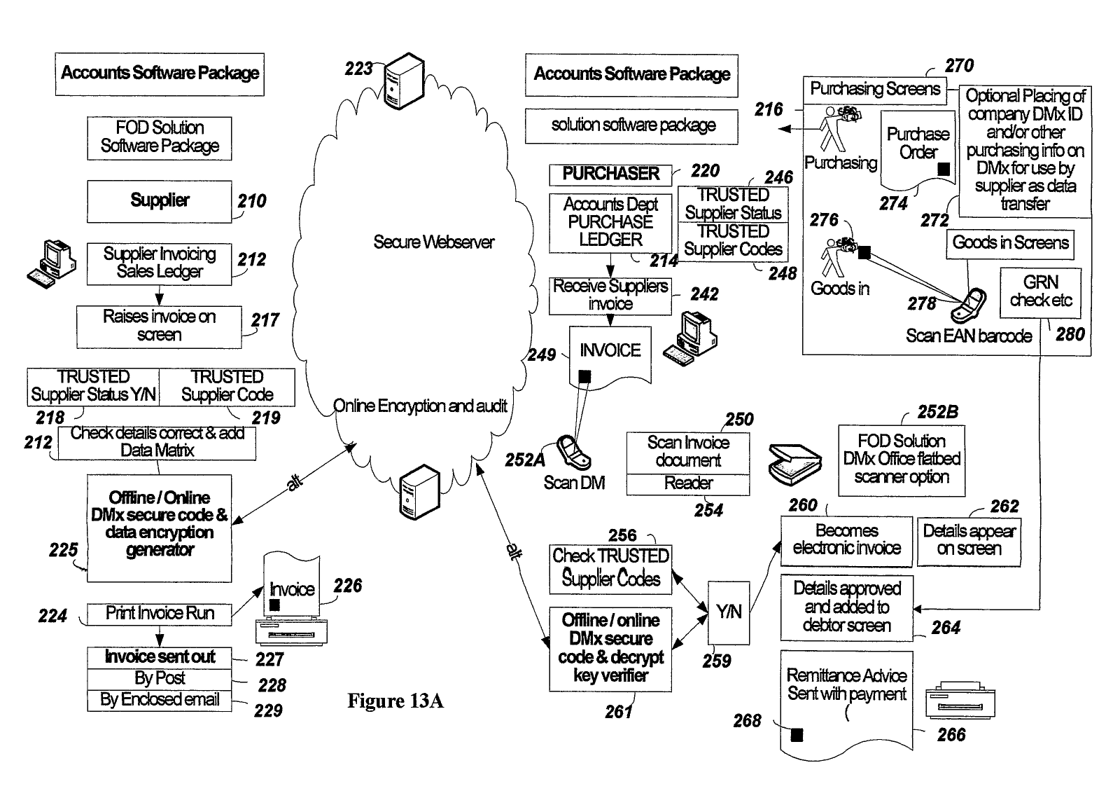

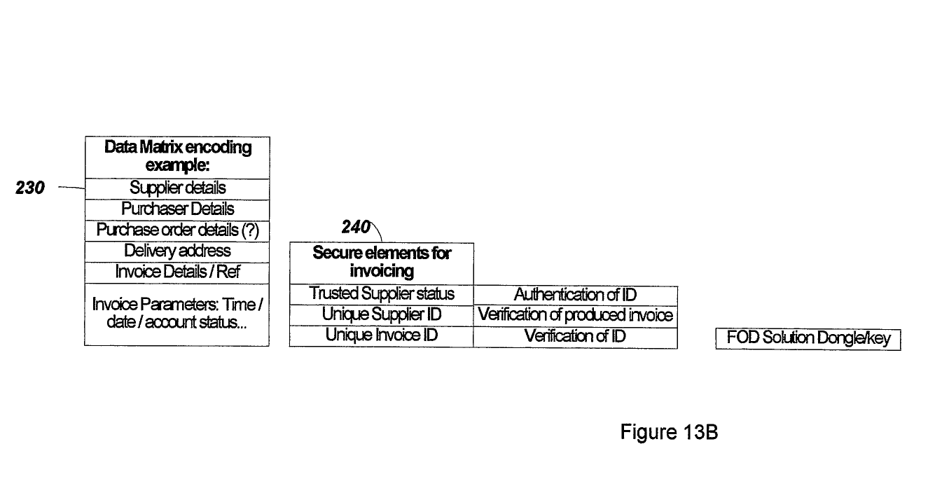

FIGS. 13A and 13B are a schematic diagram of an embodiment of the invention.

The system to be described provides a secure, web service based, authentication system for printed and other media types using data carriers such as Data Matrices and RFID. The system has a core generic part, which includes components that support generic functional requirements. The core components are extended on an application by application, or customer-by-customer to support specific industry requirements. These specific extensions are referred to as “wrappers”. The system is not limited to the Internet or World Wide Web but may be implemented on any type of network, for example a company private network. In many applications, embodiments of the invention will interface with existing networks of a user or set of users. The system to be described may be used in a variety of different applications although the present application is concerned with its use in the authentication and validation of invoices.

The concept of a value-based token (VBT) is fundamental to the design of the solution and is discussed here briefly. A fuller description is given below.

A VBT is a mechanism that allows a unique entity to be created, printed (or delivered via another channel) and subsequently authenticated. All VBTs have a unique identity, the ability to store data and security features to prevent their content and structure being amended maliciously. For example, a VBT generated for a money-off coupon may contain a unique token number, details about the product the coupon can be used against and a message authentication code (MAC) used to identify if a token has been altered.

The preferred data carrier for the VBT is the Data Matrix (DMx). However, other data carriers may be used depending on the nature of the VBT and the data to be carried, and the geographical region in which the solution is to be implemented. The nature of the data carrier is described in detail below. Data Matrix is an encoding standard used to produce a 2-D barcode such as the one show in FIG. 1. It can be included in a document, on some other form of printed media or could even be applied to a product itself. At some point in the VBTs life it will be read (scanned) and then authenticated and/or redeemed by the system.

A Data Matrix encodes information digitally in the form of a checker pattern of on/off. Data Matrix is defined by ISO standard, ISO/IEC16022—International Symbology Specification, Data Matrix.

It is possible, in some embodiments of the invention, that the VBT will never be printed, for example if it remains in electronic form. In such a case, the VBT may not need to be encoded on a data carrier.

FIG. 2 provides an overview of the interaction between a wrapper (industry implementation) and the core. The core includes a database, for example an Oracle 10g database which holds data to be included in the VBT and data which is related to data held in the VBT, as discussed below. The core is responsible for creation, updating and delivery of VBTs as well as the creation of formatted versions of VBT for inclusion on the selected data carrier. The core is also responsible for the processing of scanned data carriers to authenticate them and to update the database to show that a given VBT has been redeemed. The wrapper holds information that is specific to an application so that, for example, where the data carrier is applied to a coupon, the wrapper will hold information that is specific to that application, such as the data structure of the VBT, the type of encryption used and the data carrier into which the VBT is to be formatted. This approach makes is simple to adapt the system to new applications for the VBT.

The various functions of the core shown in FIG. 2 will now be described in more detail.

Creation 10: During token creation, the core creates a unique identity for the VBT and stores it in the token repository (database 12). A VBT will carry data relevant to its application although it is not a data store in itself. For example, a VBT used to secure a cheque may contain the payee, account and amount. The wrapper is responsible for passing all application specific data to the core. Each type of VBT will have specific security requirements defined in a security policy. For example, a simple voucher may only need a message authentication code to prevent data being changed whereas a bank cheque may require encryption and a digital signature. The core will apply these security features automatically during creation. The structure of the VBT is discussed below.

Update 14: A wrapper may need to update a token during its life, usually to change its status. The core allows updates providing they do not violate the rules defined for the token type, e.g. a wrapper can change the token status from ‘created’ to ‘active’.

Format for data carrier 16: A wrapper can request that a VBT is built for a particular data carrier, for example a Data Matrix or RFID. The core chooses the appropriate software application for the data carrier and uses it to construct a VBT of this type. New providers can be plugged in to the core and configured for use via an administration interface.

Deliver 18: The core allows a wrapper to send tokens via supported channels. Messages sent via the core can use generic XSLT templates to format messages. Alternatively, a wrapper can construct a message itself and simply send it via the core. Messages may be delivered via email. Additional channels may require access to third party messaging gateways for example, to send SMS messages.

Read VBT 20: A VBT will be scanned/read at the point of use, for example a bank or a retail outlet. The content of the VBT can be used locally if required. However, to authenticate or redeem the VBT the content will be securely sent via the wrapper, e.g. a web service call. The wrapper can apply custom validation, business logic before using the core to authenticate and/or redeem the VBT.

Authenticate 22: The wrapper will pass the entire content of the VBT to the core for authentication. During this process the VBTs security features are used to validate its authenticity, i.e. PIN, MAC and signature. Where a VBT contains encrypted data the core will decrypt and return the clear text to the wrapper where additional processing can be performed.

Redeem 24: The wrapper will pass the entire content of the VBT to the core for redemption. The VBT will be checked by the core to ensure it is valid and if successful will update the VBT to a redeemed status. VBTs will normally be redeemed only once; however the core will allow tokens to be configured to allow multi-redemption of a single VBT. This may be required in some applications, where, for example, the VBT relates to a multiple entrance pass for a venue.

A typical deployment will include the core extended with a wrapper, which is a customisation for a specific application). FIG. 3 shows several deployments, each with their own wrapper. The wrapper may extend the core to implement additional data requirements, additional validation/business logic, customize the look & feel and provide a user web portal. In FIG. 3 examples of wrappers for couponing, ticketing, banking and postal applications are shown.

FIG. 4 shows the outline functionality of the system. There are five basic modules which are described in detail in relation to FIG. 5 below: Audit, Receive and Store Token Information; Generate and Distribute Value-based-token (VBT) containing Token Information; Authenticate and Redeem VBT; Administration; and Reporting. The receive and store token information module receives token information from customers who provide details of the data that is to be included in the token. For example if the token represented a money-off token, the identity of the token as a money-off coupon, and the token value, the product to which it relates and other parameters are supplied by the customer via a wrapper for that token type, as is described below. The generate and distribute module takes the token information and forms it into a value-based-token having a structure described below and then encodes the VBT onto a data carrier. The data carrier is then distributed to consumers over any convenient delivery channel such as, but not limited to, the postal services, email, fax, commercial print works and web-based distribution. The consumer is a person or even a product. The VBT may be applied to a coupon or the like that a person can redeem or may be applied to a product such a labelling or packaging. The authenticate and redeem module is responsible for verification of the authenticity of a VBT bearing data carrier when it is presented. The data carrier will be scanned and the encoded VBT recovered and verified by the system in a manner to be described. Finally the administration and reporting modules allow customers to interact with the system to provide them with selected information about the generation, authentication, and redemption of tokens by the system in accordance with their level of permissions.

FIG. 5 illustrates the software components that comprise the core. The core supports Internet and Intranet access via a browser which is also used to access the core administration interface and web service calls to APIs. Components are built using a J2EE development framework.

The following processes form part of the core solution. Each wrapper may use all or a subset of these processes to deliver the most appropriate solution

### User Account Creation

### User Account Maintenance

### Login/Logout and Session Management

Key management

### Token Creation

### Token Maintenance

Token Generation (format VBT for data carrier, e.g. data matrix)

### Token Encryption

### Multi-channel Token Delivery

### Token Authentication

### Token Redemption

### Multiple Token Redemption

### Token Batch Creation and Management

Unique Token ID generation

### Token History Reporting

### Audit Reporting

### Token Manager

The Token Manager component supports the creation and maintenance of VBTs within the core repository. It does not include any authentication or redemption functionality to provide additional security and deployment options. The token manager provides for creation of a unique entry in the core repository representing a VBT; maintenance of a history of all token events, e.g. creation, update etc. The token manager can specify an optional free text payload that will be contained within in the generated token. For example, this payload would be written to a data matrix or written to an RFID chip. This payload is referred to as the embedded payload.

The token manager can also specify an optional free text payload that is stored in the database. This payload is referred to as the additional payload. This payload will not be included when the token is generated. Additional payloads can be retrieved when a token is authenticated or redeemed. The token manager controls updating of a token's additional payload. A token can only have one additional and one embedded payload. A token's embedded payload cannot be updated unless it is in created status. If it has any another status it may already have been delivered, e.g. printed, and the delivered content cannot be amended. The token manager can specify an optional pin/password to secure a token. It is also responsible for activation and cancellation of tokens. Prior to activation any attempt to authenticate or redeem a token will fail. A token is only valid between its start and end dates. These dates include a time element. The token manager can create tokens for different data carriers.

A token's security features, such as whether it contains a digital signature, are defined in a security policy. The following combinations of token, wrapper (payload) and security data may be supported:

### Token

### Token+Payload

### Token+Payload+MAC

### Token+Payload+Digital Signature

The payload can be clear text or encrypted depending on the application. Every token event (creation, update etc) can be audited and a token batch can be created and used as a logical grouping of tokens. A batch includes a meaningful name. A token may be assigned to an existing batch.

The core supports an extensible token lifecycle so that new statuses and the valid transitions between statuses can be defined. The token manager can also redeliver an existing token, for example, if the original has been lost.

The operation of the token manager will be better understood from the following use cases.

| | |
|---|---|
| Use Case Name: | Create Token |
| Actor/Role: | Wrapper |
| Description: | Create VBT entries within the repository |
| Pre-Conditions | Wrapper is authenticated and authorised to use the |
| | service. Where a batch is specified the batch must |
| | already be created. |

### Flow:

1. Wrapper sends token details to the Token Manager component. As a minimum the token type is required. Other optional attributes include:

| | |
|---|---|
| PIN | Security code required when using token. |
| Payloads | Data to be carried with the token. |
| Start date | Date from which the token can be used. |
| End date | Date at which the token expires. |
| Status | Status to be assigned after creation. |
| Redemption Limit | Max times VBT can be redeemed (default 1) |
| Batch Identifier | Batch token should be assigned to. |

2. Validate that the token type is available for the current service.
3. Validate token details. The PIN preferably has an alphanumeric value up to 30 characters in length. If an additional payload has been specified, i.e. it will be held in the database, the token type must be validated to confirm this type of payload is supported. If a status other than ‘created’ has been specified it must be a valid transition from ‘created. The batch must exist.
4. Generate token identification number [TIN]. This will be generated via the Security Manager that provides random number generation. The TIN may, for example be of fixed length such as 16 digit numbers for the TIN. However it is preferred that the TIN length is configurable as this further increase the flexibility of the system.
5. Generate token key. This value is also generated using the Security Manager's random number generator. This is a unique internal key for the token which will be used when referencing the token externally, e.g. from an email. As the key is not embedded within the token it is more difficult for malicious users to obtain.
6. Retrieve the security profile for this service/token. This will determine how the token should be constructed. The security profile will include:
Hash Hash/HMAC function used for MAC
Signature Cipher used for digital signature
Encryption Cipher used for encryption
Method Describes which security features to use.
7. Apply security policy to generate VBT string. If required, calculate the message digest of the token header and payload using the Security Manager. One suitable standard is HMAC-SHA256.
If required, calculate the digital signature of the token using the Security Manager. One suitable standard is RSA-SHA256.
8. Create token and its payload (s) within the repository.
9. Create a token history record containing all the token details.
10. Write an audit record of type ‘TOKEN_CREATION’ for the event.
11. Return the TIN to the wrapper

### Use Case Name: Update Token

### Actor/Role: Wrapper

Description: Amend VBT details (e.g. setting status to ‘active’)
Pre-Conditions: Wrapper is authenticated and authorised to use the service.
Where a batch is specified the batch must already be created.

### Flow:

1. Wrapper sends token details to the Token Manager component. In addition to the TIN the attributes may include:
PIN Security code required when using token.
Payloads Data to be carried with the token.
Start date Date from which the token can be used.
End date Date at which the token expires.
Status Status to be assigned after creation.
Redemption Limit Max times VBT can be redeemed (default 1)
Batch Identifier Batch token should be assigned to.
2. In addition to the validation checks performed for these attributes in the ‘create token’ use-case the following checks should be performed. The embedded payload can only be updated if the token has a status of created. If a new status is specified it must be a valid and current transition as defined in the Token Management component.
3. Re-apply security policy to generate VBT string.
4. Update the token and payload (if amended) within the repository.
5. Create a token history entry in the repository.
6. Write an audit record of type ‘TOKEN_UPDATE’.

### Use Case Name: Generate Token

### Actor/Role: Wrapper

Description: Generate a VBT for specific data carrier (e.g. data matrix)
Pre-Conditions: Wrapper is authenticated and authorised to use the service

### Flow:

1. Wrapper sends request to the Token Manager. The TIN will be specified to identify the token. The wrapper may also use the attribute: Data Carrier. In a preferred embodiment, two data carriers are supported:
→Text: Simply returns the raw VBT string.
→Data Matrix: Encodes the VBT string using data matrix symbology.

### 2. Validate the TIN and Data Carrier.

3. Retrieve the provider (class responsible for encoding the VBT string) for the data carrier.
4. Encode the VBT string for the requested data carrier. For example, where the data carrier is data matrix a 2-D barcode will be generated using the data matrix image or font generator.
5. Return encoded VBT to the wrapper
6. Write an audit record of type ‘TOKEN_GENERATE’.

### Use Case Name: Create Batch

### Actor/Role: Wrapper

Description: Create a batch (logical container for VBTS)
Pre-Conditions: Wrapper is authenticated and authorised to use the service.

### Flow:

1. Wrapper sends request to the Token Manager component. An optional batch description can be specified.
2. A batch is created with a unique identifier.
3. Return batch identifier to the wrapper.

### Token Manager API

The following Java API's will be exposed to wrapper modules. The APIs are built to allow new commands to be added as required without altering any existing API calls.

createToken—Create a token as per the use-case described above.
updateToken—Update an existing token subject to the use-case describes above.
generateToken—Encode the token into a Data Matrix or other token formats such as RFID.
createBatch—Creates a new batch in the token repository and returns its ID to the calling module.

### Authenticate

The authentication component is responsible for authentication of tokens when they are read or scanned.

If a token has been signed the signature must be validated during authentication. An invalid signature will result in authentication failure. If a token contains a MAC this must be validated during authentication. An invalid MAC will result in authentication failure. During authentication a check is performed to confirm that the token exists within the repository. A missing token will result in authentication failure. During authentication the token's start and end date must be checked together with its status. When a status is defined it will be assigned a flag that identifies whether it will cause authentication to succeed or fail. For example, a status of ‘created’ may cause authentication to fail and a status of ‘active’ may result in success. If a token has been secured with a PIN, the PIN should be supplied and checked as part of the authentication process. If the supplied PIN does not match the original value the authentication process will fail.

On successful authentication or redemption the additional payload is returned (if requested).

All authentication requests successful or otherwise should be audited. The manner in which the authentication component operates will be understood better from the following use cases.

### Use Case Name: Authenticate Token

### Actor/Role: Wrapper/Web Service

### Description: Verify Token Details

Pre-Conditions: Actor is authenticated and authorised to use the service.

### Flow:

1. Wrapper sends token content to the Authenticate component. It also specifies whether the additional content should be returned on successful authentication and any PIN details specified by the user.
2. Retrieve the security profile for this service/token type using the service management component. This must be the policy in place at the time the token was created.
3. If a PIN is required to use the token the PIN value supplied must be processed to ensure it matches the PIN digest stored in the repository.
4. If the security policy specifies a digital signature use the Security Manager to validate the signature. If the signature is invalid return an authentication failure status.
5. If the security policy specifies a hashing algorithm use the Security Manager to validate the message digest. If the message digest is invalid return an authentication failure status.
6. Confirm the token exists in the repository and that its status contains a valid ‘authenticate’ flag.
7. Validate the tokens start and end dates.
8. If a token's redemption count must be less than its redemption limit (the maximum number of times it can be redeemed).
9. If all the above steps have passed the validation process returns a valid status to the actor and the additional payload (if requested)
10. Write an audit record of type ‘TOKEN_AUTHENICATE’.

### Authentication API

The following Java APIs support the authentication use-case above. Although a default authentication Web Service is part of the core most wrappers extend the authentication process. In this case the Java APIs can be used to support the requirements of their redemption process.

authenticateToken—using the security features on the token, this API verifies that the token is genuine and has not been tampered with.
authenticatePIN—compare the PIN stored against a token with a user supplied value.

### Authentication Web Services

AuthenticateToken—this service supports the authentication process defined in the above use-case. If the service consumer requests the token's additional payload it is returned only on successful authentication.

### Redemption

This component is concerned with redeeming tokens after they have been authenticated.

Before redeeming a token it must pass all token authentication tests. A token can only be redeemed if it has a status is flagged as ‘redeemable’. For example, the token statuses ‘created’, pending’, ‘approved’ and ‘redeemed’ may be defined and tokens may only be redeemed in they have a status of ‘approved’. A token can be redeemed more than once, with the maximum number of times a token can be used being defined for a token at its creation. By default a token can only be redeemed once.

All attempts to redeem a token are written to an audit log, and when successfully redeemed a token's status is updated to ‘REDEEMED’ (or to a specific status).

The operation of the redemption component is further explained by the following use case.

### Use Case Name: Redeem Token

### Actor/Role Wrapper/Web Service

Description: Amend token details (e.g. setting status to ‘active’)
Pre-Conditions: Actor is authenticated and authorised to use the service

### Flow:

1. Actor sends token content to the redemption service including any PIN details specified by the user.
2. Token is fully authenticated as per the Authenticate Token use-case. If authentication fails a failure response is returned to the Actor.
3. Token status is updated to ‘redeemed’ (or to whatever status the actor has requested, subject to transition rules).
4. Increment the redemption count.
5. Write the transaction to the audit log.
6. Return the redeemed payload to the Actor.

### Redemption API

The following Java APIs support the redemption use-case above. These can be extended to support a custom redemption process.

redeemToken—Redeem the token as per the use-case defined above.

### Redemption Web Services

RedeemToken—this service supports the redemption process in the above use-case. On success the redeemed payload is returned.

### Identity Management

This component only manages basic account information. This includes a ‘display name’ that may be used for reporting purposes and default values for e-mail address and/or mobile that can be held as default values for the appropriate delivery channels. Users of the system authenticate themselves using a username/password. Calls to service based functions (web services) can authenticate via username/password or Certificate Based Authentication (x509.3). An administrator may register new users via a User Interface (UI)

### Identity Management API

The following Java APIs are exposed to the wrappers.

authenticateUser—authenticate a user's credentials and create a new session.
isSessionValid—returns true if the current session is still valid.
getSession—returns the current session which can be used to identify the user's account and other session details.
maintainAccount—create and maintain user account details.
hasRole—returns true if the current session has been assigned a particular role.

### Identity Management UI

The following user interfaces are provided for the identity management component.

Login—Basic login screen. Username/password authentication.
Error Page—A generic error page used to display authentication, page access and general error messages.
User Registration—This screen allows administrators to create accounts for new users and assign them an appropriate role.

### Reporting

The reporting component is responsible for the reporting functionality. Reports will be called from the administration screens and provide flexible reporting based on audit records written by the core components. Redemption reporting can report on both successful and unsuccessful redemption attempts. Successful redemption records include the date/time stamp, account, token type and optional location id if provided by the web service. Failed redemption attempts include date/time stamp, account, token type, optional location id if provided by the web service and information about the reason for the failure. Each token listed in the redemption report provides drill down functionality to get further information about the token. Reports can summarize the status of all tokens or a subset of the tokens as defined by parameters provided to the report. This report accepts dates, service and token type as parameters. A status summary report provides a drill down to get further information about the tokens in each status. A token report by status lists all the tokens in the given status that fall within the parameters passed to the summary report. It is possible to drill down on each token. The complete history of a token can be reported and a status summary report is available to report on the tokens associated with a batch.

The core reporting functionality does not include management information in the preferred embodiment. This is implemented on a wrapper-specific basis.

The reporting included as part of the core falls into the following categories:

### Audit Reporting

### Redemption Reporting

### Token Reporting

The audit reporting provides parameterised reports on the application audit table. This report may be parameterised based on a date or date range, the service, the audit level or the audit type. Each of these parameters is optional.

The redemption report provides information about successful redemptions and those that have failed. The redemption report may be parameterised based on the service, a date or date range and the token type. The report provides detail about the account and a ‘location id’ if provided by the web service. The failure report also includes any error codes that will provide further information about the reason for failure.

The token report lists a summary by status of all tokens within the system. This report has optional parameters of service, token type and date or date range. The token report by status provides information about the date the token was updated to the selected status and the account that requested the update. Each token will link to a token history report.

The token history report provides information on each status transition that the token has made. It will also report on the accounts that requested the transition, the date and any additional details that may have been supplied e.g. delivery channel, error code or location id. This report will include both successful transitions and transitions that have failed.

It will be appreciated that the reporting functionality available is highly advantageous as it allow tracking of tokens by the token creator. This may, for example, be the issuer of a money-off coupon who wants to track how many coupons have been issued and redeemed.

Audit Manager

The audit manager component handles audit requests. The core allows custom audit types to be defined (for use in a wrapper). Audit requests include an audit level. This allows the audit component to be configured to only record events within an audit threshold. All events associated with a token are audited and written to a token history. It is also possible to add a cryptographic seal to audit records, e.g. a digital signature produced using HSM, to provide evidence if the content of the audit record is modified.

Within the core components there are two types of auditing: Core Application Auditing and Token Auditing. The core application auditing allows audit records to be written for a range of actions. The actions that are audited are controlled at a service level. Each piece of audit information is categorised according to the Audit Type e.g. Login, UpdateReferenceData. Each Audit Type has an associated audit level. The level of audit required is associated with the service within the application reference data. Before an audit statement is written a check is made to see whether the audit record to be written has an audit level less than or equal to that defined for the service. Any audit record with an audit level in the correct range will be written to the audit able.

Each Audit Record will include the following information:

A date/timestamp indicating when the record was written;
Information showing the type of audit record that is being written and the audit level assigned to that information;
The service that the audit record has been written for;
An optional message—to store non-standard details;
Information about the account that triggered the writing of the audit record—this will always populated unless the audit record is for something like a failed log in.

A separate table is populated to support the token auditing requirements within the core application. Each time a token is created or a change is made to an existing table. A record is written to a table that records information about changes made to the tokens. This provides a complete history of the token life cycle for each individual token.

Each Token History Record includes the following information:

The id associated with the token that has been created or updated;
The account that created or updated the token;
A date/timestamp indicating when the record was written;
A short description from a list of allowable values that will describe why the record was written;
A flag indicating whether the record has been written after a successful update or a failure;
Any error codes returned by the application will also be included in the token history record if the creation/update of the token was a failure;
If an activate call is made the delivery method and detail values are populated to record the route via which the token was delivered;
If the validity dates of the token are changed the new dates will be recorded in the history record.

If an authentication or redemption web service call is received that includes information about the location where the web service has been called from e.g. a till id/store id/merchant id this is stored in the history record.

### Audit Manager API

writeAudit—create an application audit record.

The core and wrappers can create data that is auditable to the highest standards. This allows the system to provide non-repudiable data. This ability is integral to the reporting linked to unique identities represented by the TINs and their authentication path. It means that value based transactions can be safely performed whether the value is monetary or otherwise. However with true audit level data sitting behind the normal reporting modules, linked to the client's wrapper behind it) “transactional monetary Properties” can be safely associated with it. Therefore when an authentication and redemption of a VBT representing a coupon, ticket, voucher note etc is done it can be linked to a real monetary transaction such as a micro payment or some other form of banking system like money transfer. This gives clients the ability to do financial reconciliation in real time if they require. The level of security and trust in the entire system allows a client to make real financial links and account in the true sense. Thus the presence of non-repudiable data is highly advantageous. One aspect of non-repudiation is time of creation. Reliance on system time is not sufficient as it can be manipulated. Embodiments of the present invention enable a non-repudiable time stamp to be applied to VBTs which can be relied on.

### Security Manager

This component handles security within the core and preferably uses the Public Key Infrastructure (PKI). PKI is a set of technologies, standards and procedures that define an enterprise-level security infrastructure. Components of PKI include:

Secret (symmetric) keys
Public and Private Keys (asymmetric keys or KeyPairs)
Digital Signatures, which use Hashing algorithms and Message Digests

All cryptographic functionality may be implemented using the Java Cryptography Architecture (JCA) and Java Cryptography Extensions (JCE) APIs.

The security manager seals tokens with a MAC which can be validated by the core. A digital signature can be created for a token using a service's private key and can be validated by the core. The content of a token can be encrypted using a service's private key and the content can be decrypted. The core supports generation of true random numbers, e.g. to produce token Ids, and stores a token's credentials (PIN/password) securely, e.g. using cryptography to store a message digest generated from the credentials.

### Security Manager API

The following security commands will be provided via a java API. The API is built to allow new commands to be added as required without altering any existing API calls.

createMAC—creates a message authentication code using the key/algorithm defined for the service/token type.
validateMAC—validate a token's MAC using the key/algorithm defined for the service/token type.
encrypt—encrypt data using the key and cipher defined for the service/token type.
decrypt—encrypt data using the key and cipher defined for the service/token type.
createSignature—create a digital signature using the private key and cipher defined for the service/token
validateSignature—validate a token's signature.
createMessageDigest—create a message digest using a specified hashing function, e.g. to create a PIN hash
generateTRN—generates a true random number.
applySecurity—apply a security policy to a VBT.

### Delivery Manager

The delivery manager enables messages (which may include a VBT) to be sent via different channels. The delivery manager is an extensible component allowing support for new channels to be developed and plugged in without modifying the interface between the wrappers and core and is shown in FIG. 6.

The core supports multi-channel delivery of VBTs which may, for example, include email delivery. A message template may be defined that will be used to deliver a token via a specific channel. Whenever a token is sent via the delivery service an audit record is written.

### Delivery Manager API

SendMessage—delivers a token via a specified channel using a template defined for the service/token type.

### Service Management

The token management component allows an administrator to create and maintain the reference data associated with a token. An administrator may create a service via a user interface (UI) The Service Management UI enables an administrator to assign supported token types to service, and to create and maintain service roles. The administrator can create and maintain token statuses and configure tokens to enable or disable the use of additional payloads. A token status indicates whether redemption is possible and also indicates whether a token would pass authentication in this state. An operator may update token details in a batch, i.e. the same change is applied to multiple tokens for example, activating all the tokens in a batch. The core can support an extensible token lifecycle, making it possible to define new statuses and the valid transitions between statuses.

As there are a number of tables that need to be populated in order to configure the core components, there is a requirement to provide administration functionality to support updates to these tables. Administration functions and screens are only required for tables where the account holders or administrative account holders need to be able to make updates. A range of administrative functions is required to manage accounts within the core components. These functions allow for the creation of accounts and account maintenance. Whether these provide “self service” functionality or “administrator-only” functionality is determined at a wrapper level by the implementation of appropriate account types.

These functions maintain the tables within the core component schema and also the basic information that will be held in the LDAP directory to support login functionality. All administrative changes that are made by application screens are audited using the appropriate audit types so that a full history of the changes made and the actioning accounts is maintained.

### Service Management UI

Administration Screens may provide for the following:

Service Configuration—this screen allows administrative users to update the audit_level, error_level and audit_method of the service. The service information screen also allows the security policy associated with the service to be updated.

Communication Templates—the screen allows templates (e.g. an email template) to be created and updated by users with the appropriate permissions. Service/Account Mapping—a screen and/or API is provided to add new accounts to the appropriate service. An account must also be assigned an account type for each service to define the level of access the account holder has. The administration screen also allows for updates to the account type.

Account Types—A screen is provided to create account types and associate them with the appropriate roles to define their usage of the core components. The screen also allows administrative users to maintain the roles associated with account types.

Audit Types—A screen is provided to maintain the audit types available within the system in case any of the audit levels need updating.

Service Delivery Options—A screen is provided to maintain the delivery options that are available on a service-by-service basis. This screen will enable administrative users to switch delivery options on and off for the appropriate service.

Token Statuses—this screen allows administrative users to create and maintain token statuses.

Token Status Transitions—this screen allows administrative users to define valid transitions between token statuses.

Security Policy—this screen allows administrative users to define and maintain token security policies. These policies define the security

Update Token—Maintain existing token details, e.g. change status, end date etc. requirements used during token generation, e.g. should a digital signature be created, using which algorithm.

Reporting—menu access to the reporting homepage

The database used in the core may be any suitable database such as an Oracle 10g database.

The structure of the value based token (VBT) will now be described in more detail.

FIG. 7 shows the structure of the VBT. The token contains a contents portion 30 and a security portion 32. The contents portion 10 is divided into a header portion 34 and a payload portion 36. The header comprises a first data set DS1, and the payload contains a number of further data sets DS2-DSn−1. The security portion comprises a further data set DSn. Typically the header will contain a data set having at least three sub-data sets. The first 38 identifies the type of token. This is required in any open system in which the token could represent a number of different things such as an identifier for a medical prescription or an identifier for virtual money. The Token type data set identifies the nature of the token. The second data sub-set is a Token Identification Number (TIN) 40. The TIN is a unique number that identifies a particular token. The Third data sub-set is a PIN (Personal Identity Number) 42 and comprises a flag. Depending whether this flag is set on or off, the person presenting the token for redemption will be required to validate the token with their PIN number which will be compared with a number stored in the data set 42. The header section appears in all tokens whatever their application. It uniquely identifies a token and indicates whether the token is PIN protected. Thus the header content is:

header: <type><tin><pin flag>

Type: Identifies the type of VBT (5 digits)
Tin: Unique VBT Identifier (16 digits)
Pin flag: Flag indicating pin requirement (1 digit

Preferably, the header is not encrypted. This is important in an open system in which the token type must first be read before a decision can be made as to what token type it is and, therefore, how it should be processed. The header, therefore contains information about the token itself.

The payload will vary depending on the nature of the token and its application. It contains information, which is related to the use to which the token be encoded in a relatively small data carrier such as a data matrix, the actual data need not be stored in the payload. Instead an identifier is stored which, when read, enables data associated with that identifier to be retrieved from a database. Thus, for example, the database at the core/wrapper or elsewhere may store the bank account number, cheque number and sort code number of a cheque, together forming a bank identity. The payload merely holds data, such as an address that is sufficient to retrieve this bank identity from the database. The payload may be encrypted but it will be appreciated that the system is inherently secure as the information stored in the payload is meaningless, even when decrypted, without access to the database.

The content of the payload is specific to a wrapper and may even be omitted in some applications. The payload may comprise a plurality of data sets. In the description of the core above, these may comprise one or more datasets that are an additional payload and may be a reference to data or relational structures that are stored elsewhere, for example in the core repository. Each data set may be intended for a different purpose, for example for a different party or service.

Thus, the content part of the Value Based Token comprises a header data set which contains data about the token itself which may be unencrypted and may be divided into a number of sub-data sets; and a payload data set which may be encrypted and which contains a reference to data relating to the subject of the token enabling that data to be retrieved.

If the token's security policy specifies that the payload is encrypted the cipher (encrypted text) will be stored in the payload. Due to the binary nature of encrypted data it will be base encoded before storing it in the VBT. One suitable encryption algorithm is the AES symmetric algorithm for encryption of payload content. Thus:

Payload content: <free text>|<cipher text>

The security mechanism 32 will vary according to the intended use of the token and the type of data carrier on which is encoded. The security mechanism is a cryptographic fingerprint and protects the payload and header from tampering and counterfeiting. For example, the security mechanism may comprise a SHA 256 Hash or an RSA Digital Signature. A Hash has the advantage of being small in size and can be generated quickly, whereas a digital signature is larger and takes longer to generate and verify, but is inherently more secure and non-repudiable. The appropriate security mechanism will depend on the use to which the token is being put and the degree of security required. For example, a token which represents a small discount on an item form a supermarket will require much lower security than a token that represents personal cash or a cheque.

Thus, the content and size of this section is determined by the security profile defined for the token type and the key strength used in security algorithms.

Security content: [<message digest>|<signature>]

Message Digest If the security policy specifies a hashing algorithm, the message digest is produced by the hashing the <header> and <payload>.

Signature: Where a signature is specified in the security policy the <header> and <payload> sections will be hashed and the resulting message digest signed with the service's private key to generate a digital signature. Due to the binary nature of message digests and digital signatures values will be base encoded before storing in the VBT.

It follows from the foregoing discussion of the core and the wrapper that the core defines the structure of the VBT and that the core also preferably defines the header and the security portions. The wrapper for that application may define the payload contents, which are specific to each application. Thus the syntax and semantics of the header and security portions are defined in the core as well as the supported encryption algorithms for the customer payload. The complete VBT is stored in the core but the payload is defined and constructed in the wrapper. If the payload contains references to other data or relational structures, for example due to capacity constraints of the data carrier, these too will be defined in the wrapper.

FIGS. 8 and 9 show how different VBTs can be constructed, depending on the application and the data capacity of the data carrier. FIG. 8 shows a data heavy VBT and FIG. 9 a data light VBT. In FIG. 8, the payload contains 1 or more data sets which, when read, are routed through a local data set router 100 which communicates with the system server 102 to authenticate the token TIN and routes the payload data sets to different end points. In the example of FIG. 9, there are three data sets in the payload: DS2, DS3 and DS4. DS2 is routed to a local authentication points such as a till, DS3 is routed to a marketing department and DS4 is routed to some other end point. An individual data set may be routed to more than one point, and the data in the data sets may have a degree of overlap.

In the FIG. 9 case, the VBT is data lite and comprises a header and a security section only. The payload is stored at the core server and referenced by the TIN in the header. In an alternative, not shown, the payload could include a data set that is a reference to data or relational structures stored elsewhere.

FIGS. 10 and 11 show intermediated cases where the payload carries some actual data but also references data stored elsewhere. In FIG. 10, the payload includes data sets 2 and 3. A fourth data set is stored at the wrapper database are is pulled when the TIN is provided for authentication. In the FIG. 11 example, one or more of the data sets in the payload is linked to supplemental data, shown as stored at the wrapper database. Thus, the TIN references the data sets and the supplemental data. This again reduces the amount of data that needs to be carried in the VBT.

FIG. 13 shows the lifecycle of a VBT. A token may exist in a number of states: Created, suspended or redeemed. A change in status may occur through the activities of activation, cancellation or authentication.

The content of the VBT depends not only on the intended use of the token, but also on the nature of the data carrier that is going to be used to carry the VBT. Many types of data carrier are available. The data carrier is a portable data transport medium and, must be capable of storing identity data string components. A data carrier is usually a type of barcode or RFID device.

The data transport is constructed to have the generic format of the VBT:

| | | |
|---|---|---|
| Header | Payload | Security |

By using a common VBT for all applications, the common format and approach can be adopted even though different markets and applications have different requirements on how to place ‘identity’ data (or portable credential) onto an item and what that data item must include. For example, the level of security used may vary from minimal to very high. This has an implication on the amount of data that must be held in the data carrier and, in turn, what data carrier is appropriate. At one extreme, the VBT may have just a header and a security portion having low security. At another extreme, the VBT may include high security and a payload having several data sets each including a large amount of data. In between these extremes, the payload may have one or more data sets one or more of which may comprise a reference to data stored elsewhere.

Existing 1D barcodes (for example EAN 13 and EAN128) and 2D symbologies need may be used. Examples are QR code and Maxi code, and the Data Matrix (DMx). PDF 417 barcodes, RSS (Reduced space symbology) codes and RSS Composite (1D plus 2D) may also be suitable.

Embodiments of the invention may be used in environments in which a chosen Data Carrier is already used, whether it is a printed or marked barcode or a RFID type carrier. This preexisting barcode type may be required for the solution as already have printing devices and scanning technology. In some cases, the VBT may be added to existing data carriers, such as a carrier used by a customer for other purposes. This is particularly possible on RFID devices which have a relatively large storage capacity but may also be possible on other carriers.

It is possible to create hybrid data from the actions and status of a client or consumer, for example by updating information and/or the data sets to create a new VBT either on the existing or a new data carrier. How the new hybrid VBT is sent to the data carrier depends on the Wrapper but follows the same route for its predecessor but may occur at a different place. In a particular solution user Rules may be require the first carrier to be scanned again before the second is scanned providing a two part verification process building a authentication picture. This is desirable, for example, in a ticketing situation. For a coupon the new VBT may be an update of where a customer had used the coupon and what status had changed, ready for the coupon to be used again. In this context a receipt printed at a till could easily print out a new carrier.

Table 1 below shows a number of examples of data carriers that may be suitable for use with embodiments of the present invention, depending on the requirements of the application.

TABLE 1

1D Barcode type (traditional range) eg EAN 13 or 128
Data Matrix (ISO/IEC standard 16022)
QR Code (ISO standard 18004)
PDF 417 (ISO standard 15438 - June 2001)
Maxi Code -
Vericode
RFID - all types (including Gen 2) also known as Radio Barcodes)
CHIP -

Thus, the VBT is first created and holds the final identity output created in the system core before it is encoded onto the data carrier of choice. The VBT has header, payload and security components as specified in the wrapper that is specific to that application. Encoding the data into/onto a Data Carrier will not alter the information of the original VBT data string. Therefore in the example of the DMx it would turn the VBT into a DMx image which when scanned would translate back into the original VBT content. In an example of RFID the VBT would be onto the RFID tag.

It is preferred to optimise all data to suit the data carrier type. This may involve using specific character sets or Base encoding to reduce unnecessary content overhead such as encountered when creating a DMx. Some data carriers have specific input formats.

In some applications, the data carrier will be held by a third party. An example is a manufacturing company who have their own data carrier (DC) generating software. A DC output can be an image or more common to a font generator so is treated like text. The font must be installed on the processing machine to see or print the image. The VBT may be sent out raw from the system for encoding by the customer.

When the system described serves a Data Carrier output, for example a DMx, it needs to suit the client's requirements. If a client has different delivery channels: mobile, print via web, print to print company, print to marking technology etc. then the solution must be able to serve the optimal output for that channel. This is relevant to all 1D barcode and 2D symbologies where if an output is to an image format rather than a “font” then the physical size, dpi or pixel size has to be considered and matched to the requirement. In an example where a consumer could choose from a range of options to collect his coupon such as phone, home print etc, kiosk the system is able to create specific graphic outputs.

In one embodiment of the invention, more than one type of carrier output may be provided. For example, an RFID tag may be used with a traditional printed barcode. In that case, the system may supply two identities: the DMx and RFID information. These identities may be the same but allow for different scanning routes. In one embodiment of the invention, where a single DMx, or other chosen data carrier, is not able to contain all the data or where 2 identities need to be issued to a single item (containing different information or for different uses), then two or more data carriers may be issued.

FIGS. 8 to 11 also show how a data carrier with an encoded VBT may be read. The data carrier is first scanned to recover the VBT. The header in the VBT is not encrypted and from this the scanner, shown as the VBT Parser can determine the nature of the VBT. For example, it may identify the VBT as a coupon, a cheque, a ticket etc. This may affect the way in which the recovered VBT is processed. In FIG. 8 the VBT is constructed as data lite, which means that there is no payload. The TIN in the header is used to authenticate the wrapper and is used to access data sets that are stored elsewhere. In FIG. 9, the VBT is data heavy and the datasets are in the VBT payload. Thus, in FIG. 8, the VBT is recovered by the VBT parser, which sends an authentication request including the header and cryptographic fingerprint data sets to the authentication service. The TIN is recovered and compared with the TINs stored in the core repository, and if there is a match and authentication confirmation is sent to the parser as described above. In addition, data that is associated with the TIN, which is shown stored in a wrapper repository, but which could be elsewhere. This data comprises one or more data sets and may comprise data that is in the payload in the data heavy example. These data sets are pulled by a data set router and distributed to on of a number of recipients. As shown in FIG. 8, different recipients may receive different data sets although it is possible for each recipient to receive any or all of the data sets. In the FIG. 9 case, the data sets stored in the wrapper database in FIG. 8 are already part of the VBT and are pushed by the client data set router to their intended destinations.

The data-lite model for the VBT shown in FIG. 8 enables discretionary (DAC) and mandatory access controls (MAC) to be placed on the content referenced by the TIN in the core database. Discretionary access controls are generally granted by a person such as the object owner and determine read and write access privileges to the object to users and groups of users. Mandatory access controls are enforced by the operating system or data base and protect classified data that has been protectively marked or labelled from being inappropriately accessed or disseminated to those with insufficient security clearance. This is a multi-level secure (MLS) implementation of core suitable for Government applications such as a National Identity card scheme.

For a VBT that represents the identity of a person in the form of a serial number, this scheme can be used to control the type of information that is returned about that person. In order to implement this level of control the core database needs to know who is making the request; what role the person is fulfilling; and the location from where the request is being made. This identity based information can be obtained from an X509 certificate identifying the client making the information request. The client is a trusted node in the network with a pre-defined security clearance.

The manner in which a data carrier may be presented to a user may vary according to the application. For example, where the VBT represents a coupon for redemption in a supermarket or other store, the user will access the website of the supermarket or a particular supplier or manufacturer and be able to download the coupon. This will involve a VBT being generated and encoded onto the data carrier as described above. The user can then print the coupon including the data carrier a present it for redemption at the supermarket checkout. Alternatively, the coupon need never be printed but may remain in electronic form for redemption against electronic purchases.

Thus embodiments of the invention use a value based token which is encoded onto a data carrier. The VBT comprises a clear header, a payload, which may be encrypted, and a security section. The header is a data set which allows the VBT to be identified and may comprise a number of sub-data sets. The payload is a further data set, which contains information, which allows a reader access to data. The payload could be split provided that the reader is able to distinguish between two different data sets. As the payload does not contain actual information about the token, but a pointer to where that information is stored, the security of the token is improved. Moreover, the token is far more flexible that prior art examples which are limited by the ability of the data carrier, such as a data matrix or bar code to carry information. As the information about the token is not actually held in the payload, this problem is avoided.

The VBTs are generated, stored, authenticated and redeemed by a system, which comprises the core and one or more application specific wrappers. This approach provides a system, which can generate tokens for a wide range of applications with all common operations being performed by the core and application specific operations performed by the application wrapper. Thus, different data carriers may be used, or different payload structures used without affecting core operations. This is highly advantageous.

FIG. 12 shows how cryptographic functions are handled. All cryptographic functionality may be implemented using the Java Cryptography Architecture (JCA) and Java Cryptography Extensions (JCE) APIs. The cryptographic functionality within the core may use nCipher's netHSM Hardware Security Module (HSM). The netHSM is a FIPS 140-2 Level 3 validated security boundary, i.e. a proven certified security boundary meeting cryptographic best practice. As shown in FIG. 16, the HSM is accessed using nCipher's JCE provider implementation (nCipherKM JCA/JCE CSP) to perform encryption, decryption, key generation etc. Other JCA/JCE providers could be used.

Referring to FIGS. 13A and 13B, an implementation of the system described above is shown in which information is encoded onto the invoice, which can be read electronically at both the supplier and at the purchaser. As described above, the data is stored in a VBT which is encoded on a data matrix or other glyph or carrier. Alternatively, the data may be referenced by the VBT and actually stored elsewhere.

Referring to FIG. 13A, a supplier and a purchaser are represented generally at 210 and 220. Invoices are raised by the supplier's invoicing department and are entered onto the sales ledger of their accounting system. At the purchaser, incoming invoices from suppliers are received by the purchaser's accounts department and entered into a purchase ledger at 214.

In many cases, the purchaser has first issued a purchase order, which may be issued from a purchasing department, indicated generally at 216.

At the supplier, an invoice is initially generated on screen at 217. The supplier will be asked by the accounting software whether they have trusted supplier status for the purchaser they are invoicing. This is illustrated as a yes/no question at 218. If the answer is yes, the supplier is required to input a trusted supplier code 219. This is a code that has been provided to the supplier by the purchaser. At this point, as well as producing an invoice in a conventional fashion, the software encodes relevant details into a data matrix that is added to the invoice. Once the user is happy with the invoice on the screen, they select an “add data matrix” function. A data matrix generator 225 generates data from the invoice and the supplier details as discussed below and encrypts the data before encoding it on the data matrix. As discussed above, the data is encoded using the VBT structure with the data either being held as VBT payload or stored remotely with the VBT payload comprising a reference to the stored data; the data lite model described above. Encryption and generation of the data may be performed online or offline. FIG. 13A illustrates an online encryption server 223 which may be accessed by the supplier computer system running the accounts package via a secure HTTPS connection. This allows the parameters and permissions to be set regarding the generation of an invoice.

Once the data matrix has been generated the invoice can be printed at 224. The printed invoice will contain the data matrix. One of the advantages of a data matrix is that it is capable of being printed on a relatively low-resolution printer 226 without loss of data integrity. The printed invoice may then be sent out to the purchaser at 227, for example by post 228 or email 229.

The data encoded in the VBT, or referenced by the VBT may be viewed as two layers of data indicated generally at 230 and 240. The first layer of data is an electronic representation of the invoice details. This is relatively low security data and may be encoded in the data matrix using a first encryption algorithm. The first data layer may therefore include information necessary for the supplier to pay the invoice such as the following:

Supplier details
Purchaser details
Purchase order details (if applicable)
Invoice details including a reference
Invoice parameters such as time, date, account status and amount of invoice.

These data elements are given as an example only and other invoice information may be used according to supplier purchaser preferences.

Thus the first data layer comprises data relevant to the invoice.

The second layer of data 240 encoded in the data matrix is a secure data layer which encodes information regarding the relationship between the supplier and the purchaser. As this is more sensitive than the actual invoice details it is encoded using a different encryption algorithm. In some instances it may be preferred that the actual invoice details are not encrypted in the first data layer.

Thus, the second data layer includes elements such as the trusted supplier status 218, the trusted supplier identification code 220 and a unique identifier for the invoice that is being sent.

The secure data in this layer provides three items that can be checked at the supplier. First the identification of the supplier allows the supplier to be authenticated; then the invoice can be verified and finally the invoice number can be verified.

At the purchaser 220, invoices are received at 242. Traditionally, an invoice would be matched to a purchase order, if the company in question uses purchase orders and details of the invoice would be added to the system manually. This gives ample opportunity for errors to be introduced and is inherently insecure.

The data comprising the first data layer may be encoded directly onto the VBT with the second layer data being stored remotely and referenced by the VBT. Alternatively, both sets of data could be stored remotely and referenced from the VBT or stored as part of the VBT.

The purchaser maintains a store of trusted supplier status accounts 246 and trusted supplier codes 248. It is from this store that trusted supplier status and supplier codes are first assigned to suppliers.

When an invoice 249 is received, a data matrix reader 252 scans the invoice document at 250. This could be a handheld scanner as shown at 252a or a document scanner as shown at 252b which, as well as scanning the data matrix, could scan the remainder of the invoice document.

The data matrix scan will retrieve the data layers from the VBT. Initially, the system must establish whether the invoice has come from a trusted supplier. Thus, the second data layer is decrypted and decoded to retrieve the trusted supplier status and trusted supplier code. This takes place at steps 254, 256 and 258. This retrieved data is compared against records of trusted supplier status accounts and supplier codes 246, 248 and the invoice is verified if there is a match. This is performed at step 259. The process includes using a data matrix secure code and decrypt key verifier 261, which may be on-, or offline. If online, the unit communicates over an HTTPS secure connection with the encryption server 223 which may be operated by an appropriate authority or hosting party.

Because the VBT encoded on the data matrix also includes or references all the invoice data in the first data layer, the invoice can be retrieved electronically from the data matrix to provide an electronic invoice 260 without the need for all data to be input manually by an operator. Once the first data layer has been retrieved, the details of the invoice appear on screen at 262 and a decision can be made as to whether or not the invoice should be approved. If it is, the invoice will be added to the debtor list in the accounts package at 264. At an appropriate time, the invoice can be paid with the appropriate remittance advice being sent either as a paper copy or electronically. In each case, the remittance advice may include a data matrix 268, which includes the data on a second data layer of the VBT encoded on the matrix. This is illustrated at 66. The data matrix may be the same data matrix as used on the invoice that is being paid or may be a fresh data matrix with information relevant to the payment stored in it. That data matrix can then be scanned by the supplier on receipt of the remittance advice enabling them automatically to link the remittance advice to the invoice in their creditor balance.

The invoice information is stored in the data matrix together with field code that enables the scanned data matrix information to be mapped to the purchaser's accounts package to be populated into the correct fields of the invoice at the supplier. This will depend on the accounting packages used by both supplier and purchaser.

It will be appreciated that even if the scanning of the data matrix and the subsequent analysis of the data retrieved from or via the VBT shows the supplier not to be a trusted supplier, the invoice details can still be retrieved and entered into the purchaser's accounts systems from the VBT on the scanned data matrix. However, the processing at the purchaser is different as the invoice is not trusted.

In one preferred embodiment, the supplier may scan the data matrix before the invoice is dispatched. This allows the supplier to have confidence that an invoice that has been raised has actually been sent out.

In one preferred embodiment, the data in or referenced by the VBT encoded on the data matrix may first be used at the purchase order stage 216. When a purchase order is raised by the purchaser for goods or services from a particular supplier it will first be displayed on a purchasing screen 270 and a VBT may be generated and encoded on a data matrix included on the order at 272, which includes the supplier's trusted supplier status and trusted supplier codes, the purchaser identifier and possible other purchasing information. A purchase order including a data matrix is shown at 274.

Similarly the VBT encoded data matrix may be used to check whether goods that have been invoiced having actually been received. A data matrix with a VBT carrying an identifier may be affixed to the goods as shown at 276 and, on receipt, is scanned at 278. Information from the data matrix may be passed to the accounting system as part of a goods received notification so to be reconciled against the corresponding invoice. Instead of affixing a new data matrix to goods, use may be made of existing identifiers such as bar codes, which are already carried by the goods. These may be scanned and the information passed to the accounting system to reconcile receipt of the goods with invoice information scanned in from the data matrix on the invoice for the goods. In this manner, existing information regarding goods received is integrated into an accounting system in a manner that, hitherto, has not been possible.

In large organisations, or organisations raising large invoices, permissions may be granted to members of staff who have authority to raise such invoices. At purchasers, similar permissions may apply to staff that have authority to settle invoices. A range of permissions may be granted giving authority for different levels of invoicing or payments. These permissions may be encoded into the VBT on the data matrix, for example into the second data layer. Thus the purchaser has access to the permissions level of the person issuing an invoice.

This can be checked with the supplier using the encryption server 223. At the supplier, the invoice creation software includes code to ask the user whether they have permission to raise a particular invoice and code requiring the user to enter an identifier allowing the permission to be checked. This may be an ID code or a signature for example.

It will be appreciated from the foregoing description that embodiments of the invention hold great advantage particularly for trusted supplier/purchaser partners. Data that is included in the layers stored on or referenced by the VBT has access permissions associated with it, which further prevent non-trusted parties abusing the system. Systems embodying the invention bring a high degree of security to invoice generation and reconciliation. That security itself brings a high saving in man-power and time as it is no longer necessary to enter details of invoices received from trusted suppliers by hand.

It will be appreciated that both supplier and purchaser will be in possession of the same information encoded in both the data layers. This makes is simple for an online audit to take place between the two parties in the invoice generator and the verifier. For example, this may be achieved using https encrypted session data. In the figure this is shown as taking place via the intermediary encryption server 223, which is preferably a server, or group of servers run, by the data matrix service provider or some other third party or host and is therefore ideal as an intermediary for audit purposes. The use of online auditing will highlight when no trusted status exists and can ensure that appropriate actions can be taken. It will also ensure that fraudulent invoices are not generated from within the trusted supplier as a comparison can be made between the invoice references, the amounts and the record of the permissions of the person at the supplier who raised the invoice. In this way, invoices drawn up, legitimately or not, by someone who is exceeding their granted authority will be detected and can be investigated before they are paid.

In the foregoing description, use is made of trusted identifier, which is encoded into a graphic symbol and included in an invoice. Where the invoice is physically printed, the data matrix is also printed but it may exist only in electronic form. The trusted identifier in the embodiment comprises both a trusted supplier status and a trusted supplier code. The trusted supplier identifier may take other forms and be more or less complex. For example, it may comprise a single identifier or more than the two identifiers disclosed. The use of a yes/no status and a status code is useful for large organisations. A trusted supplier may provide a wide range of goods and/or services to a purchaser. Although the supplier is trusted, the degree of trust may between different goods and services. The degree of trust may be reflected in the trusted supplier code and will affect the actions taken by the purchaser on receipt of an invoice.

In one alternative embodiment of the invention, a third party permissioning authority may grant trusted supplier status. In this environment, a supplier will not know whether a purchaser has the capability of reading a data matrix printed on an invoice. Nevertheless, they may choose to print the data matrix on all invoices even if the invoice is dealt with in a conventional manner by the purchaser. This authority may be the service provider and the store of trusted supplier status and codes may be at the encryption server 223. Parties to the system may supply the third party with details of suppliers to whom they have granted trusted status and also with updated statuses so that the system recognises changes in status.

Embodiments of the invention have the advantage that security at both ends of the invoicing process can be improved. The raising of fraudulent invoices within a trusted party can be detected and invoices from non-trusted parties can be easily detected and handled differently to those received from trusted parties.

The embodiment described may be provided as an add on package to existing accounting software, for example that sold by SAGE Group PLC as mentioned above or any other accounting software. If provided by the accounts package provider, the product may carry a product key identifier and a user identifier key. A dongle may be used at the supplier end to secure access to the system acting either as a hard coded key or an active translator.

In one alternative embodiment that data matrix may be used only for security purposes in which case only a single layer of data need be encrypted on the data matrix: the layer which includes the secure elements for invoicing 340 including the trusted supplier status and supplier code. Although it is preferred that the data matrix also includes the invoice data, as this has considerable advantages, the security advantages of the present invention may be met even if the actual invoice data is not included.

In the foregoing example, it has been assumed that the data contained in or referenced by the VBT encoded on the data matrix is actual invoice data and trusted supplier data. This data may be encrypted for additional security. Many methods of encryption exist, and the type of encryption that is suitable in a given application is a question of choice for one skilled in the art. One approach is to use public/private key encryption in which the public key is stored on the data matrix in encrypted form and a private key is stored in a database and can be used to authenticate the public key. The public key is freely available, and linked to an identity certificate of the owner.

When public/private key encryption is used, it is necessary for a trusted certificate authority to issue a certificate and digital signature to the party printing the data matrix. The certificate itself can be validated by the issuing authority, which also holds a Certificate Revocation List and Key History. The Certificate Revocation List contains a list of all certificates that have been revoked, and is separate to a list of expired keys. A list of expired keys can be used to re-issue keys and ensure that the keys are varied. A key history is necessary to allowing tracking of individual keys throughout the lifetime of the data matrix, for example, for the duration of a passport containing the data matrix. The list of expired keys and the key history can therefore be used together to reduce the likelihood of any compromise to the data matrix security.

If public/private key encryption is used, then when printed, a hash is prepared from the intended data content of the data matrix. The hash is then encoded with the signing algorithm of the printers private key, and a digital signature and copy of the public key are provided as part of the data matrix. On validation, the public key is used to prepare a hash, using the same signing algorithm as the private key, and is compared with the original hash. If the two hashes are the same, the data matrix is validated and is proved to have been unchanged since the original signing.

The unique information that is printed on the data matrices is both stored in a central store or database and represented as encrypted data using proprietary algorithms to prevent the information printed in the data matrices being decrypted. There are a number of ways in which this may be achieved. The presently preferred method is to hash the data and to include nonce in the key. Nonce is in essence random data obtained from the cryptographic random number generator. The hash can then be encrypted and the encrypted hash is stored on the data matrix or other identifier. The combination of hashing, encryption and the use of a unique identifier which is coupled with a copy stored in a central store ensure that fraud is minimised as attempts to duplicate data matrices will be detected and any invoices containing duplicated data matrices will not be honoured. Moreover, as the data is represented in a hashed and encrypted format it is much more difficult for any attempt to be made to reproduce the identifiers.

A cryptographic functions module is responsible for encryption of the data stored on the data matrix. Thus, the unique information that is printed on data matrix is both stored in a central store and represented as encrypted data using proprietary algorithms to prevent the information printed in the data matrix being decrypted.

A secure key store includes a database and is the repository for the keys that are issued. Instead of a database, a hardware security module or any other secure storage device could be used. Not all keys are placed on the data matrix but are issued to each party to the trusted relationship. The exact format will depend on the type of encryption used and whether it is symmetric or asymmetric.

The secure key store records those keys that have been used, or where appropriate, partially used. The secure key store can only be accessed through a secure management system and is protected by firewalls and back up systems.

It is not actually necessary that the data matrix stores all the data on the actual invoice or trusted supplier data. The data matrix may merely store the public key for the encrypted data. This allows the user, who has the private key, to retrieve the data from the central store. The key gives access to that invoice only and must therefore include an invoice identifier. The central store may be linked to the encryption server and controlled by a third party or it may be under the control of the supplier. The key may give permission for the invoice data to be accessed once only or to be accessed multiple times. This information can be retrieved or downloaded via a secure network such as an HTTPS Internet connection.

Many modifications to the embodiment described are possible and will occur to those skilled in the art without departing from the scope of the invention, which is defined solely by the following claims.

1. A system for generation and verification of invoices between a supplier and purchaser comprising:
a store of identifiers of trusted suppliers;
an invoice generator for generating invoices, each invoice including a graphic symbol having encoded therein the supplier's trusted identifier or a reference to the supplier's trusted identifier;
a scanner at the supplier for scanning the encoded graphic symbol for retrieval of the trusted supplier identifier; and
a verifier for comparing the retrieved trusted supplier identifier with stored trusted identifiers to authenticate the invoice as originating from a trusted supplier.

2. A system for generation and verification of invoices between a supplier and purchaser according to claim 1, wherein the graphic symbol further includes an encoded invoice identifier or a reference to an invoice identifier.

3. A system for generation and verification of invoices between a supplier and purchaser according to claim 1, wherein the trusted supplier identifier comprises a trusted supplier status.

4. A system for generation and verification of invoices between a supplier and purchaser according to claim 3, wherein the trusted supplier identifier further includes a trusted supplier code.

5. A system for generation and verification of invoices between a supplier and purchaser according to claim 1, wherein the trusted supplier identifier is encoded in, or referenced by, a first data portion on the graphic symbol.

6. A system for generation and verification of invoices between a supplier and purchaser according to claim 5, wherein the graphic symbol comprises a further data portion having invoice data encoded therein or referenced thereby.

7. A system for generation and verification of invoices between a supplier and purchaser according to claim 1, wherein the graphic symbol is a data matrix symbol.

8. A system for generation and verification of invoices between a supplier and a purchaser according to claim 1, comprising an encryption server arranged for encryption of the trusted supplier identifier prior to encoding in the graphic symbol.

9. A system for generation and verification of invoices between a supplier and a purchaser according to claim 8, wherein the encryption server is an on-line server.

10. A system for generation and verification of invoices between a supplier and a purchaser according to claim 9, wherein the encryption server is connectable to the purchaser for decryption of trusted supplier identifier retrieved from received invoices by the purchaser.

11. A system for generation and verification of invoices between a supplier and a purchaser according to claim 1, wherein the supplier invoice is raised in response to a purchase order from the purchase order, comprising means at the purchaser for generating a purchase order including a graphic symbol having the supplier trusted identifier encoded or referenced thereon and means at the supplier for retrieving the supplier trusted identifier and encoding it or a reference to it into the graphic symbol included in the invoice generated by the supplier.

12. A system for generation and verification of invoices between a supplier and a purchaser according to claim 11, wherein the purchase order graphic symbol includes a purchase identifier or a reference to a purchase identifier.

13. A system for generation and verification of invoices between a supplier and a purchaser according to claim 1, wherein the supplier trusted identifier includes permissions data indicating the authority of an individual at the supplier to raise the invoice.

14. A system for generation and verification of invoices between a supplier and a purchaser according to claim 1, wherein status and permissions of the supplier are checked online with an authority.

15. A system for generation and verification of invoices between a supplier and a purchaser according to claim 6, wherein the invoice data encoded in or referenced by the graphic symbol includes field identifier information to enable the invoice data to be mapped to accounting software at the purchaser.

16. A system for generation and verification of invoices between a supplier and purchaser according to claim 1, wherein the graphic symbol has encoded thereon an encrypted key, the key giving access to the supplier's trusted identifier stored at a remote location.

17. A system for generation and verification of invoices between a supplier and purchaser according to claim 1, wherein the graphic symbol has encoded thereon an encrypted invoice key, the key giving access to the invoice data stored at a remote location.

18. A system for generation and verification of invoices between a supplier and purchaser comprising:
a store of identifiers of trusted suppliers;
an invoice generator for generating invoices, each invoice including a graphic symbol having encoded therein data relating to the supplier's trusted identifier;
a scanner at the supplier for scanning the encoded graphic symbol for retrieval the data related to trusted supplier identifier;
means for retrieving the trusted supplier identifier from the data related to the trusted supplier identifier and a verifier for comparing the retrieved trusted supplier identifier with stored trusted identifiers to authenticate the invoice as originating from a trusted supplier.

19. A system for generation and verification of invoices between a supplier and purchaser according to claim 18, wherein the data related to the trusted identifier comprises an encrypted key, the key giving access to the supplier's trusted identifier stored at a remote location.

20. A system for generation and verification of invoices between a supplier and purchaser according to claim 18, wherein the graphic symbol has encoded thereon an encrypted invoice key, the key giving access to specific invoice data or record stored at a remote location.
